(19) United States
(12) Patent Application Publication
(10) Pub. No.: US 2014/0046734 A1
(43) Pub. Date: Feb. 13, 2014

(54) PROACTIVE SERVICE PERFORMANCE MANAGEMENT

(71) Applicants: Kamal K. Bhattacharya, Bangalore (IN); Jayan Nallacherry, Bangalore (IN); Yedendra Babu Shrinivasan, Bangalore (IN)

(72) Inventors: Kamal K. Bhattacharya, Bangalore (IN); Jayan Nallacherry, Bangalore (IN); Yedendra Babu Shrinivasan, Bangalore (IN)

(73) Assignee: INTERNATIONAL BUSINESS MACHINES CORPORATION, Armonk, NY (US)

(21) Appl. No.: 13/570,811

(22) Filed: Aug. 9, 2012

(51) Int. Cl. G06Q 10/06

(52) U.S. Cl. 705/7.38

(57) ABSTRACT

A method and system for performance management is provided. The method includes receiving a list comprising performance and compliance metrics and associated importance ratings for a service. Optimally balanced states and worst states for each metric are determined and related Service Delivery Quotient (SDQ) values are calculated. Normalized SDQ values are generated and data indicating a circle comprising a radius R is received. A virtual circle comprising the radius R is generated from the data. The virtual circle is divided into sectors such that each metric comprises a sector angle value that is proportional to an associated importance rating. Bisectors and a star plot graph comprising the bisectors are generated.

### FIELD

The present invention relates to a method and associated system for managing proactive service management based on a service delivery framework.

### BACKGROUND

Monitoring data with respect to attributes comprises an inaccurate process with little flexibility. Data analysis may include a complicated process that may be time consuming and require a large amount of resources. Accordingly, there exists a need in the art to overcome at least some of the deficiencies and limitations described herein.

### SUMMARY

The present invention provides a method comprising: receiving, by a computer processor of a human provided service delivery computing system (HPSDS), a list comprising performance and compliance metrics and associated importance ratings for a service; determining, by the computer processor, optimally balanced states and worst states for each metric of the performance and compliance metrics; calculating, by the computer processor based on the optimally balanced states and the worst states, Service Delivery Quotient (SDQ) values for the performance and compliance metrics during a specified time period; generating by the computer processor from the SDQ values, normalized SDQ values; receiving, by the computer processor, data indicating a circle comprising a radius R; generating, by the computer processor from the data, a virtual circle comprising the radius R; dividing, by the computer processor, the virtual circle into a plurality of sectors such that each the metric comprises a sector angle value that is proportional to an associated importance rating of the associated importance ratings; generating, by the computer processor, bisectors for the plurality of sectors; and generating, by the computer processor, a star plot graph comprising the bisectors.

The present invention provides a computer program product, comprising a computer readable storage device storing a computer readable program code, the computer readable program code comprising an algorithm that when executed by a computer processor of a human provided service delivery computing system (HPSDS) implements a method, the method comprising: receiving, by the computer processor, a list comprising performance and compliance metrics and associated importance ratings for a service; determining, by the computer processor, optimally balanced states and worst states for each metric of the performance and compliance metrics; calculating, by the computer processor based on the optimally balanced states and the worst states, Service Delivery Quotient (SDQ) values for the performance and compliance metrics during a specified time period; generating by the computer processor from the SDQ values, normalized SDQ values; receiving, by the computer processor, data indicating a circle comprising a radius R; generating, by the computer processor from the data, a virtual circle comprising the radius R; dividing, by the computer processor, the virtual circle into a plurality of sectors such that each the metric comprises a sector angle value that is proportional to an associated importance rating of the associated importance ratings; generating, by the computer processor, bisectors for the plurality of sectors; and generating, by the computer processor, a star plot graph comprising the bisectors.

The present invention provides a computer system comprising a computer processor coupled to a computer-readable memory unit, the memory unit comprising instructions that when executed by the computer processor of a human provided service delivery computing system (HPSDS) implements a method comprising: receiving, by the computer processor, a list comprising performance and compliance metrics and associated importance ratings for a service; determining, by the computer processor, optimally balanced states and worst states for each metric of the performance and compliance metrics; calculating, by the computer processor based on the optimally balanced states and the worst states, Service Delivery Quotient (SDQ) values for the performance and compliance metrics during a specified time period; generating by the computer processor from the SDQ values, normalized SDQ values; receiving, by the computer processor, data indicating a circle comprising a radius R; generating, by the computer processor from the data, a virtual circle comprising the radius R; dividing, by the computer processor, the virtual circle into a plurality of sectors such that each the metric comprises a sector angle value that is proportional to an associated importance rating of the associated importance ratings; generating, by the computer processor, bisectors for the plurality of sectors; and generating, by the computer processor, a star plot graph comprising the bisectors.

The present invention advantageously provides a simple method and associated system capable of monitoring data.

### BRIEF DESCRIPTION OF THE DRAWINGS

FIG. 1 illustrates a system for managing proactive service management based on a service delivery framework, in accordance with embodiments of the present invention.

FIG. 2A illustrates a process enabled by a performance and compliance combination engine component of FIG. 1 for identifying a deviation from an optimally balanced state, in accordance with embodiments of the present invention.

FIG. 2B illustrates circles, in accordance with embodiments of the present invention.

FIG. 2C illustrates a process enabled by a time series visualization component of FIG. 1 for visualizing a change in the deviation from the optimally balanced state and the orientation of the HPSDS over a given time period, in accordance with embodiments of the present invention.

FIG. 2D illustrates a process to visualize changes in an individual metric over a given time period using a radial layout, in accordance with embodiments of the present invention.

FIG. 3 illustrates an algorithm detailing a process flow enabled by the system of FIG. 1 for managing proactive service management based on a service delivery framework, in accordance with embodiments of the present invention.

FIG. 4 illustrates a computer apparatus used by the system of FIG. 1 for managing proactive service management based on a service delivery framework, in accordance with embodiments of the present invention.

### DETAILED DESCRIPTION

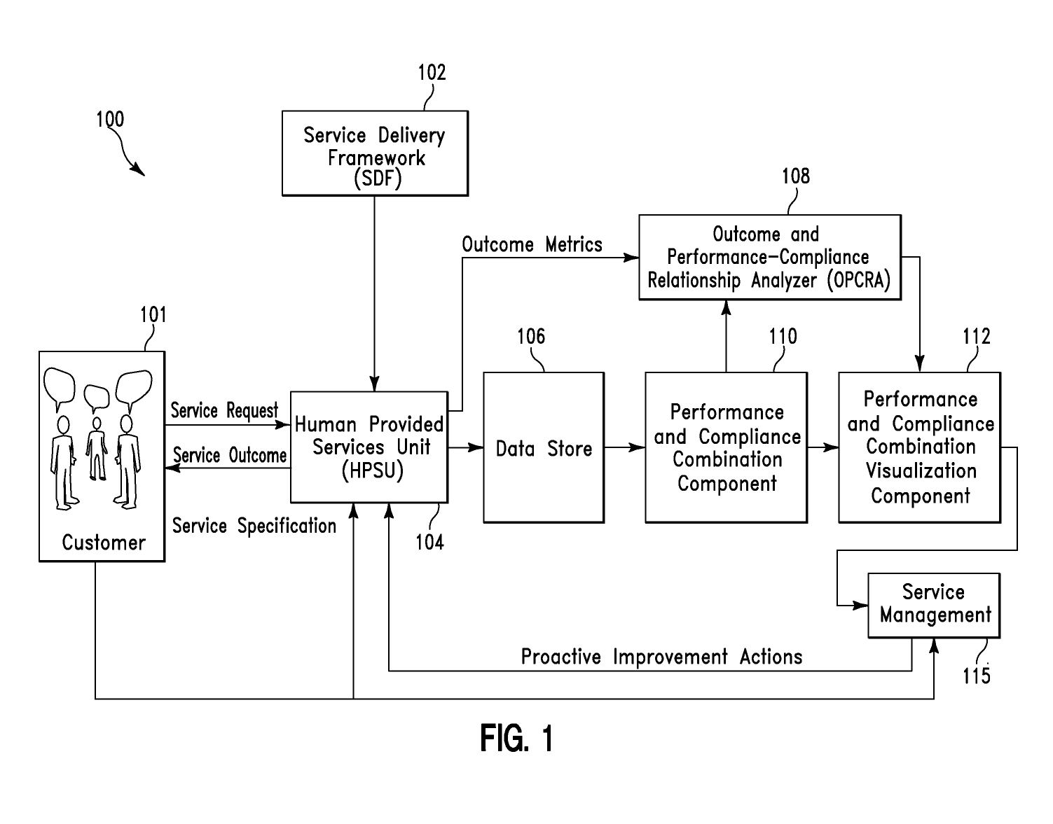

FIG. 1 illustrates a system 100 for managing proactive service management based on a service delivery framework (SDF) 102, in accordance with embodiments of the present invention. System 100 comprises a human provided service delivery computing system (HPSDS) comprising: a human provided services unit (HPSU) component 104, a service delivery framework (SDF) component 102, a service management component 115, a performance and compliance combination engine component 110, a data store 106, an outcome and performance-compliance relationship analyzer (OPCRA) component 108, and a time series visualization component 112. HPSU component 104 comprises an organization built based on SDF component 102. HPSU component 104 serves customer service requests within service specifications agreed by a customer 101. SDF component 102 comprises a set of delivery practices associated with people skills, behavior, processes & tools, and a management system. In order to serve customers, HPSU component 104 follows practices and a service delivery model specified by SDF component 102. Data store 106 archives performance and compliance metrics based on real-time and historic raw data collected from data gathering tools used in the HPSDS. The data gathering tools may be comprised by, inter alia, operations, management systems, people behavior, customer feedback, etc. OPCRA component 108 is used to predict possible outcomes based on context-based trend matching with an output (e.g., normalized performance and compliance metrics) from data store 106. Performance and compliance combination engine component 110 integrates performance and compliance metrics. Time series visualization component 112 provides a time series visualization of performance and compliance metrics. Service management component 115 evaluates services delivered and analyzed and enables necessary actions to meet customer expectations.

System 100 enables the following functions:

1. Definition of performance components based on SDF component 102.
2. Evaluation of performance components of a service processing unit (SPU) based on real-time data from the SPU.
3. Integration of results of a performance component evaluator to determine an overall performance of the SPU.
4. Prediction of future performance of the SPU based on historical data.
5. Mapping a relationship between outcomes of the SPU and associated performance components.
6. Forecasting outcomes of the SPU based on performance.
7. Visualization of past, current, and future performance of the SPU.
8. Visualization of compliance of the SPU to SDF component 102.

The following description describes an implementation example enabled by system 100:

A group of analysts administer a client IT infrastructure and deliver services required by a client. In response, service specifications (e.g., a number of necessary staff, a cost and time to resolve per service request, etc) are pre-defined and agreed upon by a service provider and client. The service provider has organized a service processing unit consisting of elements (e.g., staff, processes, tools, a delivery management system (DMS), etc) based on SDF component 102. Staff is categorized by skill levels (e.g., low, medium and high skill levels). Service requests are classified and routed through a dispatching process based on a complexity and urgency. A specified set of tools may be used to dispatch and track progress of service requests. A DMS comprises managers that overlook day-to-day operations of HPSU component 104 and provides periodic reports associated with an outcome from HPSU component 104 to service management component 115. Additionally, the DMS enforces improvement actions based on feedback from service management component 115. For example, outcomes from HPSU component 104 may include:

1. Outcome₁: A percentage of service requests that have been resolved with delay.
2. Outcome₂: A percentage of service requests that have been partially resolved with or without delay.
3. Outcome₃: A percentage of service requests that have not been resolved.
4. Outcome₄: A percentage of service requests that have been resolved on-time.

SDF component 102 identifies performance compliance metrics (PCMs) that measure now HPSU component 104 operates. Examples of the PCMs provided by a SDF component 102 may include:

1. Dispatching service requests to appropriate skilled staff (e.g., simple service requests to a low skill level, complex service requests to a high skill level, etc.)
2. Resource allocation as per SDF component 102.
3. Capabilities of staff as per SDF component 102.

Performance and compliance combination engine component 110 retrieves data required to evaluate a performance of components from HPSU component 104. Additionally, HPSU component 104 evaluates a degree of compliance of individual components with reference to PCMs defined by SDF component 102. Examples of a performance evaluation may include:

1. PCM₁: A percentage of service requests are dispatched to appropriate skilled staff.
2. PCM₂: A deviation of resources allocation compared to a resource allocation recommended by SDF component 102.
3. PCM₃: A percentage of mismatching within capabilities of staff compared to capabilities of staff recommended by SDF component 102.

OPCRA component 108 maps a relationship between results of the PCMs with an outcome of HPSU component 104. For example, Outcomeᵢ=f(PCM₁, . . . , PCMₙ) where n equals a number of performance components and i equals one to a number of outcomes from HPSU component 104. In response to the mapping, OPCRA component 108 predicts specified outcomes of HPSU component 104.

Time series visualization component 112 processes an output from performance and compliance combination engine component 110 and OPCRA component 108 and displays various states of HSPU component 104 over a specified time period. For example, in an IT infrastructure service delivery system, a group of skilled resources may administer client IT infrastructure and deliver services required by a client. System 100 enables the following functions:

1. Integrating performance and compliance metrics resulting in a combined performance and compliance indicator.
2. Determining a deviation from an optimally balanced state of the HPSDS.
3. Visualizing changes in performance and compliance metrics over time using a radial layout.
4. Enabling OPCRA component 108 for mapping a relationship between outcomes of a HPSU component 104 and associated performance-compliance metrics. In response, OPCRA component 108 predicts outcomes of HPSU component 104 based on performance-compliance metrics.

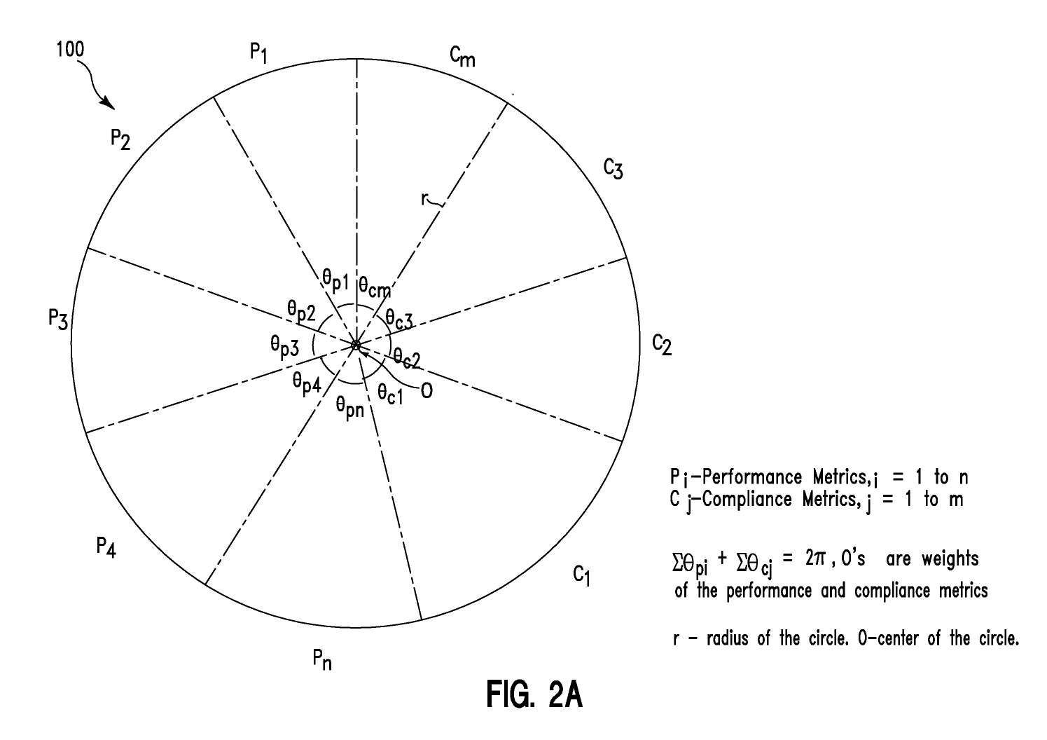

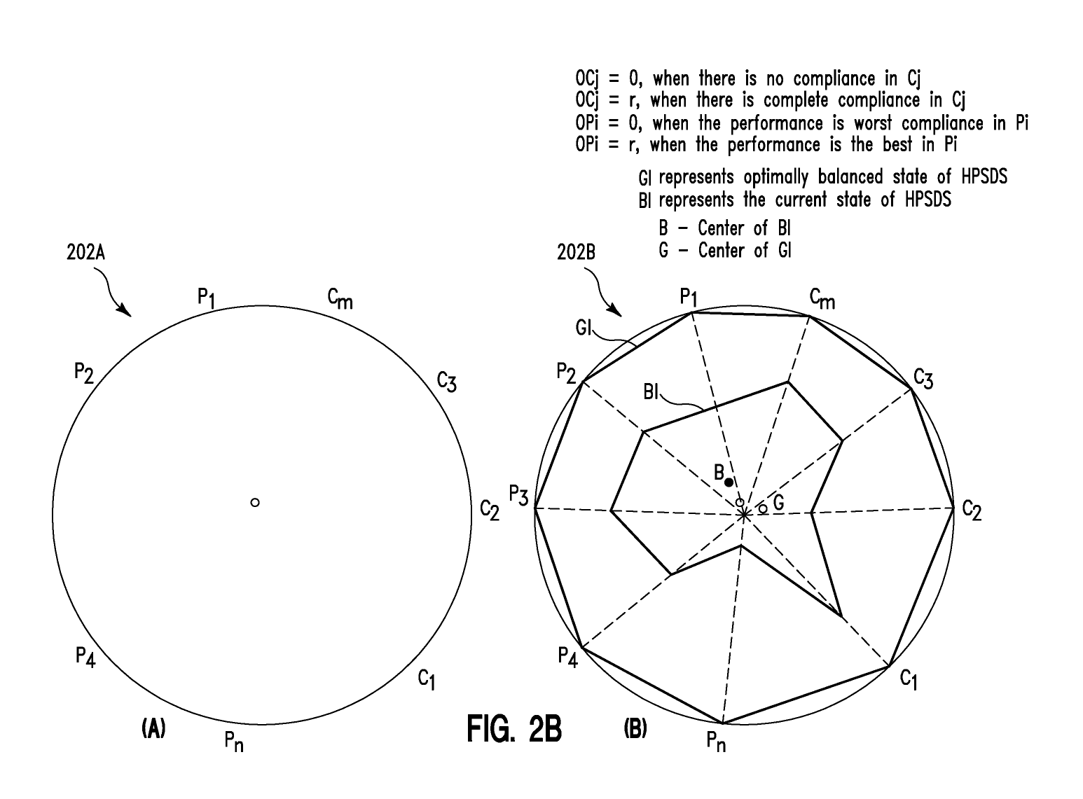

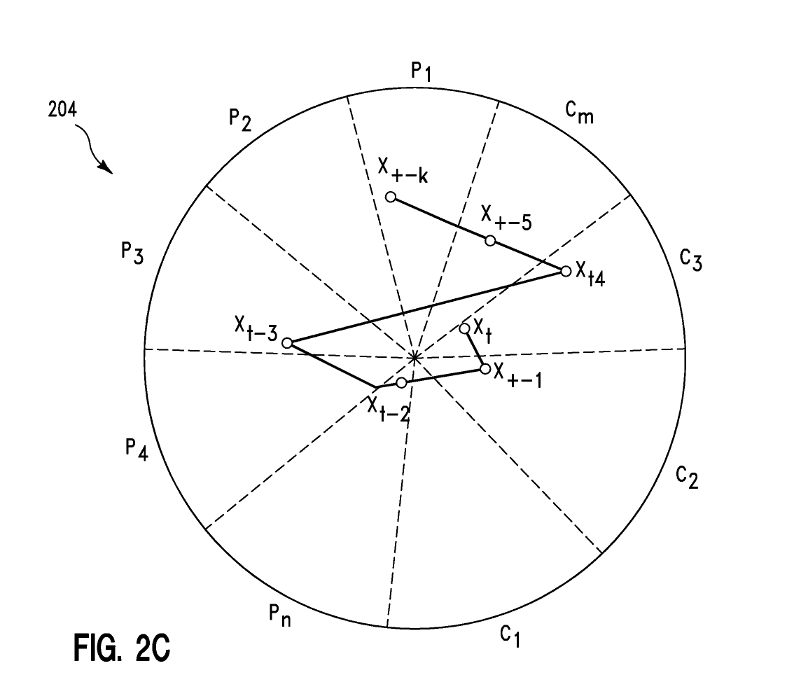

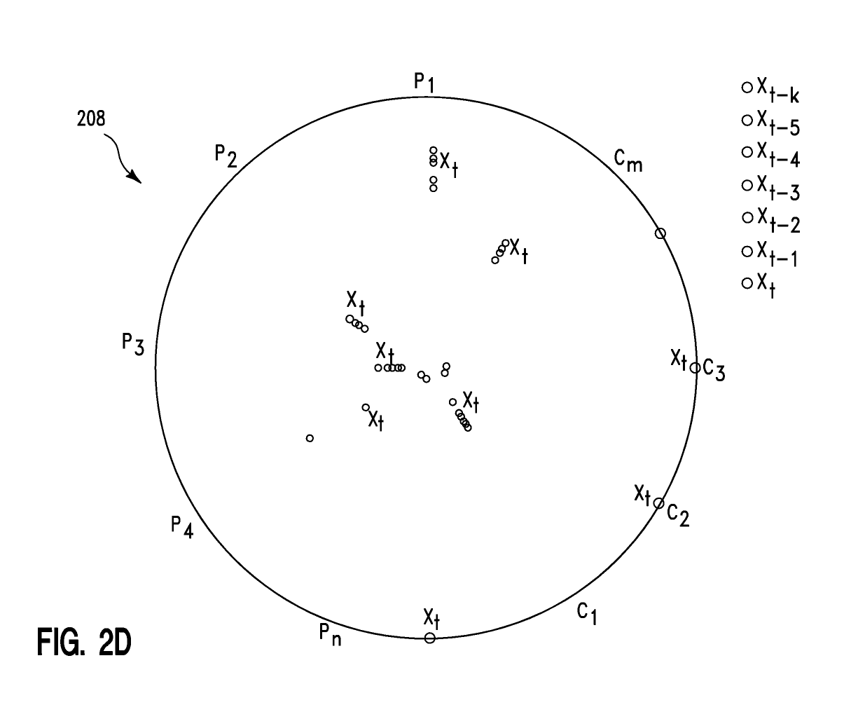

FIG. 2A illustrates a process enabled by performance and compliance combination engine component 110 of FIG. 1 for identifying a deviation from an optimally balanced state, in accordance with embodiments of the present invention. FIG. 2A illustrates a (virtual) circle 200 comprising a radius r. Circle 200 is divided into i+j sectors comprising angles (A) equivalent to the weights given to performance metrics (Pᵢ) and compliance metrics (Cⱼ). i equals a number of performance metrics (i=1 to n) and j (j=1 to m) equals a number of compliance metrics. Σθₚᵢ+Σθcj=2π, where θ comprises weights of the performance metrics (Pᵢ) and compliance metrics (Cⱼ).

FIG. 2B illustrates circle 202A and circle 202B, in accordance with embodiments of the present invention. An axis for each of performance metrics (Pᵢ) and compliance metrics (Cₐ) is established by a bisector of a corresponding sector as illustrated by circle 202A. Worst values lie at a center of circle 202A and the best values lie at a circumference of circle 202A. In circle 202B, a line is drawn for an HPSDS connecting associated performance and compliance values along each axis. A polygon G1 represents an optimally balanced state and a polygon B1 represents a current state of the HPSDS. A deviation from the optimally balanced state (SDQ) D is determined as follows:

A Center of the optimally balanced state=G.
A Center of the current state=B.
A sum of all distances between the optimally balanced state's performance and compliance metrics value points along the axis to the center of circle 202B=S_{g},
A sum of all distances between the current state's performance and compliance metrics value points along the axis to the center of the circle 202B=S_{b}.

D=\sqrt{|\vec{GB}|²+(S_{B}−S_{G})²}

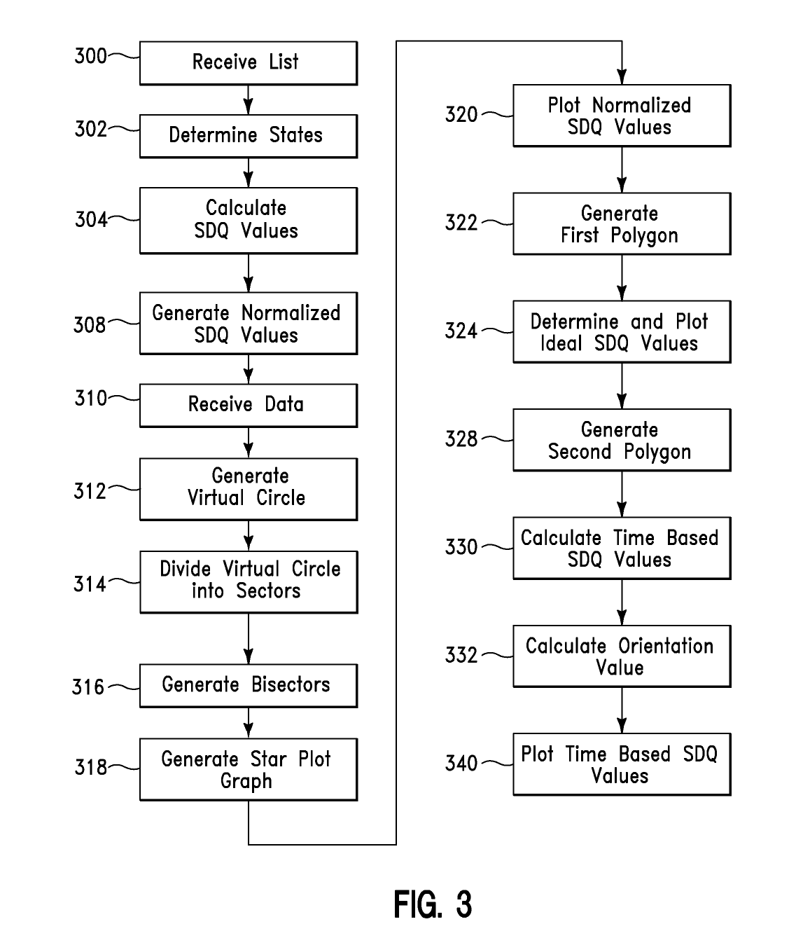

FIG. 2C illustrates a process enabled by time series visualization component 112 of FIG. 1 for visualizing a change in the deviation from the optimally balanced state and the orientation of the HPSDS over a given time period, in accordance with embodiments of the present invention. FIG. 2C illustrates a circle 204 comprising a radius R divided into sectors as described with respect to FIG. 2A, supra. R=D of the worst state of HPSDS. A position of the HPSDS at time t, xₜ is determined by (D, θ). FIG. 2C illustrates a trail of the HPSDS from time t−k to t. When xₜ is closer to the center of the circle, it is closer to the optimally balanced state. Additionally, FIG. 3C illustrates a most optimal metric of the HPSDS at time t.

FIG. 2D illustrates a process to visualize changes in an individual metric over a given time period using a radial layout, in accordance with embodiments of the present invention. FIG. 2C illustrates a circle 208 comprising a radius r divided into sectors as described with respect to FIG. 2A, supra. FIG. 2D illustrates a trail of individual metrics contributing to an overall deviation from the optimally balanced state from time t−k to t. When xₜ is closer to the center of circle 208, it is closer to the optimal value for the individual metric.

FIG. 3 illustrates an algorithm detailing a process flow enabled by system 100 of FIG. 1 for managing proactive service management based on a service delivery framework (SDF), in accordance with embodiments of the present invention. In step 300, a computer processor of a human provided service delivery computing system (HPSDS) receives a list that includes performance and compliance metrics and associated importance ratings for a service. In step 302, the computer processor determines optimally balanced states and worst states for each metric of the performance and compliance metrics. In step 304, the computer processor calculates (based on the optimally balanced states and worst states) service delivery quotient (SDQ) values for the performance and compliance metrics during a specified time period. In step 308, the computer processor generates (from the SDQ values) normalized SDQ values. In step 310, the computer processor receives data indicating a circle comprising a radius R. In step 312, the computer processor generates (from the data received in step 310) a virtual circle comprising the radius R. In step 314, the computer processor divides the virtual circle into a plurality of sectors such that each metric comprises a sector angle value that is proportional to an associated importance rating of the associated importance ratings. In step 316, the computer processor generates bisectors for each of the sectors. In step 318, the computer processor generates a star plot graph comprising the bisectors. In step 320, the computer processor plots (within the virtual circle) the normalized SDQ values. In step 322, the computer processor generates (based on the plotting of step 320) a first polygon B from the normalized SDQ values. In step 324, the computer processor determines ideal SDQ values (of the normalized SDQ values) and plots (within the virtual circle) the ideal SDQ values. In step 328, the computer processor generates (based on the plotting of step 324) a second polygon G from the ideal SDQ values. In step 330, the computer processor calculates time based SDQ values for a time t using the following equation: D=\sqrt{|\vec{GB}|²+(S_{B}−S_{G})²}. S_{B} equals a sum of all distances between ideal state performance and compliance metrics value points along an axis to a center of the circle. S_{G} equals a sum of all distances between the performance and compliance metrics value points of the HPSDS at a time t along the axis to the center of the circle. |\vec{GB}| is the distance between a center of the first polygon B and a center of the second polygon G. In step 332, the computer processor calculates an orientation value θ comprising a direction of a line from the center of the first polygon B and a center of the second polygon G associated with the HPSDS. In step 340, the computer processor calculates (within a new virtual circle with a Radius R=D of a worst state of the HPSDS) the time based SDQ values from time t to t−k, where t is a current time and k is a period.

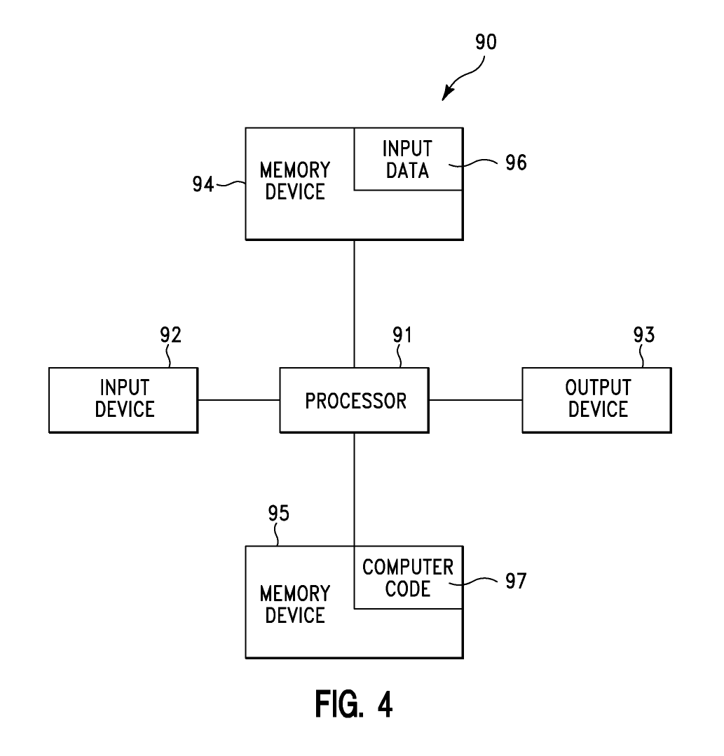

FIG. 4 illustrates a computer apparatus 90 used by system 100 of FIG. 1 for managing proactive service management based on a service delivery framework, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 3) for managing proactive service management based on a service delivery framework. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 4) may comprise the algorithms of FIG. 3 and may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise the computer usable medium (or said program storage device).

Still yet, any of the components of the present invention could be created, integrated, hosted, maintained, deployed, managed, serviced, etc. by a service supplier who offers to for manage proactive service management based on a service delivery framework. Thus the present invention discloses a process for deploying, creating, integrating, hosting, maintaining, and/or integrating computing infrastructure, comprising integrating computer-readable code into the computer system 90, wherein the code in combination with the computer system 90 is capable of performing a method for managing proactive service management based on a service delivery framework. In another embodiment, the invention provides a business method that performs the process steps of the invention on a subscription, advertising, and/or fee basis. That is, a service supplier, such as a Solution Integrator, could offer to manage proactive service management based on a service delivery framework. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 4 shows the computer system 90 as a particular configuration of hardware and software, any configuration of hardware and software, as would be known to a person of ordinary skill in the art, may be utilized for the purposes stated supra in conjunction with the particular computer system 90 of FIG. 4. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method comprising:
receiving, by a computer processor of a human provided service delivery computing system (HPSDS), a list comprising performance and compliance metrics and associated importance ratings for a service;
determining, by said computer processor, optimally balanced states and worst states for each metric of said performance and compliance metrics;
calculating, by said computer processor based on said optimally balanced states and said worst states, Service Delivery Quotient (SDQ) values for said performance and compliance metrics during a specified time period;
generating by said computer processor from said SDQ values, normalized SDQ values;
receiving, by said computer processor, data indicating a circle comprising a radius R;
generating, by said computer processor from said data, a virtual circle comprising said radius R;
dividing, by said computer processor, said virtual circle into a plurality of sectors such that each said metric comprises a sector angle value that is proportional to an associated importance rating of said associated importance ratings;
generating, by said computer processor, bisectors for said plurality of sectors; and
generating, by said computer processor, a star plot graph comprising said bisectors.

2. The method of claim 1, further comprising:
plotting, by said computer processor within said virtual circle, said normalized SDQ values; and
generating, by said computer processor based on said plotting, a first polygon B from said normalized SDQ values.

3. The method of claim 2, further comprising:
determining, by said computer processor, ideal SDQ values of said normalized SDQ values;
second plotting, by said computer processor within said virtual circle, said ideal SDQ values; and
generating, by said computer processor based on said second plotting, a second polygon G from said ideal SDQ values.

4. The method of claim 3, further comprising:
calculating, by said computer processor, time based SDQ values for a time t, wherein D=\sqrt{|\vec{GB}²+(S_{B}−S_{G})²}, wherein S_{B} equals a sum of all distances between ideal state performance and compliance metrics value points along an axis to a center of the circle, wherein S_{G} equals a sum of all distances between the performance and compliance metrics value points of the HPSDS at a time t along the axis to the center of the circle, and wherein |\vec{GB}| is the distance between a center of the first polygon B and a center of the second polygon G.

5. The method of claim 4, further comprising:
calculating, by said computer processor, an orientation value, θ comprising a direction of a line from the center of the first polygon B and a center of the second polygon G associated with said HPSDS.

6. The method of claim 4, further comprising:
third plotting, by said computer processor within a new virtual circle with a Radius R=D of a worst state of the HPSDS, said time based SDQ values from time t to t−k, wherein t is a current time and k is a period.

7. The method of claim 1, wherein a center point of said star plot graph comprises a value of zero, and wherein each bisector of said bisectors comprises a length of one.

8. A process for supporting computing infrastructure, the process comprising providing at least one support service for at least one of creating, integrating, hosting, maintaining, and deploying computer-readable code in a computer comprising a computer processor, wherein the computer processor carries out instructions contained in the code that when executed by the computer processor causes the computer to perform the method of claim 1.

9. A computer program product, comprising a computer readable storage device storing a computer readable program code, said computer readable program code comprising an algorithm that when executed by a computer processor of a human provided service delivery computing system (HPSDS) implements a method, said method comprising:
receiving, by said computer processor, a list comprising performance and compliance metrics and associated importance ratings for a service;
determining, by said computer processor, optimally balanced states and worst states for each metric of said performance and compliance metrics;
calculating, by said computer processor based on said optimally balanced states and said worst states, Service Delivery Quotient (SDQ) values for said performance and compliance metrics during a specified time period;
generating by said computer processor from said SDQ values, normalized SDQ values;
receiving, by said computer processor, data indicating a circle comprising a radius R;
generating, by said computer processor from said data, a virtual circle comprising said radius R;
dividing, by said computer processor, said virtual circle into a plurality of sectors such that each said metric comprises a sector angle value that is proportional to an associated importance rating of said associated importance ratings;
generating, by said computer processor, bisectors for said plurality of sectors; and
generating, by said computer processor, a star plot graph comprising said bisectors.

10. The computer program product of claim 9, wherein said method further comprises:
plotting, by said computer processor within said virtual circle, said normalized SDQ values; and
generating, by said computer processor based on said plotting, a first polygon B from said normalized SDQ values.

11. The computer program product of claim 10, wherein said method further comprises:
determining, by said computer processor, ideal SDQ values of said normalized SDQ values;
second plotting, by said computer processor within said virtual circle, said ideal SDQ values; and
generating, by said computer processor based on said second plotting, a second polygon G from said ideal SDQ values.

12. The computer program product of claim 11, wherein said method further comprises:
calculating, by said computer processor, time based SDQ values for a time t, wherein D=\sqrt{|\vec{GB}|²+(S_{B}−S_{G})²}, wherein S_{B} equals a sum of all distances between ideal state performance and compliance metrics value points along an axis to a center of the circle, wherein S_{G} equals a sum of all distances between the performance and compliance metrics value points of the HPSDS at a time t along the axis to the center of the circle, and wherein |\vec{GB}| is the distance between a center of the first polygon B and a center of the second polygon G.

13. The computer program product of claim 12, wherein said method further comprises:
calculating, by said computer processor, an orientation value, θ comprising a direction of a line from the center of the first polygon B and a center of the second polygon G associated with said HPSDS.

14. The computer program product of claim 12, wherein said method further comprises:
third plotting, by said computer processor within a new virtual circle with a Radius R=D of a worst state of the HPSDS, said time based SDQ values from time t to t−k, wherein t is a current time and k is a period.

15. The computer program product of claim 9, wherein a center point of said star plot graph comprises a value of zero, and wherein each bisector of said bisectors comprises a length of one.

16. A computer system comprising a computer processor coupled to a computer-readable memory unit, said memory unit comprising instructions that when executed by the computer processor of a human provided service delivery computing system (HPSDS) implements a method comprising:
receiving, by said computer processor, a list comprising performance and compliance metrics and associated importance ratings for a service;
determining, by said computer processor, optimally balanced states and worst states for each metric of said performance and compliance metrics;
calculating, by said computer processor based on said optimally balanced states and said worst states, Service Delivery Quotient (SDQ) values for said performance and compliance metrics during a specified time period;
generating by said computer processor from said SDQ values, normalized SDQ values;
receiving, by said computer processor, data indicating a circle comprising a radius R;
generating, by said computer processor from said data, a virtual circle comprising said radius R;
dividing, by said computer processor, said virtual circle into a plurality of sectors such that each said metric comprises a sector angle value that is proportional to an associated importance rating of said associated importance ratings;
generating, by said computer processor, bisectors for said plurality of sectors; and
generating, by said computer processor, a star plot graph comprising said bisectors.

17. The computer system of claim 16, wherein said method further comprises:
plotting, by said computer processor within said virtual circle, said normalized SDQ values; and
generating, by said computer processor based on said plotting, a first polygon B from said normalized SDQ values.

18. The computer system of claim 17, wherein said method further comprises:
determining, by said computer processor, ideal SDQ values of said normalized SDQ values;
second plotting, by said computer processor within said virtual circle, said ideal SDQ values; and
generating, by said computer processor based on said second plotting, a second polygon G from said ideal SDQ values.

19. The computer system of claim 18, wherein said method further comprises:
calculating, by said computer processor, time based SDQ values for a time t, wherein D=\sqrt{|\vec{GB}|²+(S_{B}−S_{G})²}, wherein S_{B} equals a sum of all distances between ideal state performance and compliance metrics value points along an axis to a center of the circle, wherein S_{G} equals a sum of all distances between the performance and compliance metrics value points of the HPSDS at a time t along the axis to the center of the circle, and wherein |\vec{GB}| is the distance between a center of the first polygon B and a center of the second polygon G.

20. The computer system of claim 19, wherein said method further comprises:
calculating, by said computer processor, an orientation value, θ comprising a direction of a line from the center of the first polygon B and a center of the second polygon G associated with said HPSDS.
